(19) United States
(12) Patent Application Publication
(10) Pub. No.: US 2003/0083866 A1
(43) Pub. Date: May 1, 2003

(54) Requirements for dynamic rate repartitioning

(76) Inventors: Massimo Sorbara, Freehold, NJ (US); Jung-Lung Lin, Holmdel, NJ (US); Leon Paley, East Brunswick, NJ (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/237,983

(22) Filed: Sep. 10, 2002

Related U.S. Application Data
(60) Provisional application No. 60/318,458, filed on Sep. 10, 2001.
(60) Provisional application No. 60/318,470, filed on Sep. 10, 2001.
(60) Provisional application No. 60/318,475, filed on Sep. 10, 2001.

(51) Int. Cl. G10L 19/00

(52) U.S. Cl. 704/212

(57) ABSTRACT

The invention provides a system and method for enabling DRR that supports multiple, simultaneous voice call events. In addition the invention provides for DRR that support the activation and deactivation of bit synchronous PCM timeslots within a well-defined period of time (e.g. not to exceed 100 ms) that can accommodate any voice call control signaling procedures, DRR that provides for robust communication of the DRR signaling protocol between the line terminal (LT) and the network terminal (NT), DRR that supports periodically refreshing the status of the bit synchronous PCM timeslots and DRR that aligns with proposed DSL bearer requirements.

### CROSS REFERENCE TO RELATED APPLICATIONS

This application claims the benefit of priority to U.S. Provisional Application No. 60/318,458, titled “Framework For Channelized Voice Using SDSL,” U.S. Provisional Application No. 60/318,470, titled “Requirements For Dynamic Rate Repartitioning,” and U.S. Provisional Application No. 60/318,475, titled “Recommendation For A 1-Bit Z Channel For DRR,” all of which were filed on Sep. 10, 2001 and all of which are hereby incorporated by reference.

### FIELD OF THE INVENTION

This invention relates to a system and method for defining system-level requirements for dynamic rate repartitioning (DRR). In particular, the invention provides a system and method that considers minimizing the time to activate and deactivate a PCM voice timeslot, allowing for allocation and deallocation of more than one timeslot in a very short period of time to avoid or minimize the impact of queuing delays on voice call processing events and providing some form of robustness or immunity to noise events in the signaling protocol dedicated to DRR.

### BACKGROUND OF THE INVENTION

In recent years telephone communication systems have expanded from traditional plain old telephone system (POTS) communications to include high-speed data communications as well. As is known, POTS communications includes not only the transmission of voice information, but also PSTN (public switched telephone network) modem information, control signals, and other information that is transmitted in the POTS bandwidth, which extends from approximately 300 hertz to approximately 3.4 kilohertz.

Prompted largely by the growth in Internet usage, the provision of xDSL services to customer premises has proliferated over recent years. In this regard, the descriptor “x” preceding the DSL designator is used to broadly denote a variety of DSL services, including SDSL, ADSL, RADSL, HDSL, etc. As is known, xDSL transmissions are sent to customer premises over the same twisted pair cabling as POTS transmission are sent. Since xDSL transmissions are communicated in a frequency band that is separate and distinct from the POTS frequency band, transmitting both types of signals over the same cabling (even at the same time), generally is not a problem. Specifically, the POTS frequency band is defined between approximately DC and approximately 4 kHz, while xDSL frequency bands (although they vary depending upon the specific service) are generally defined by a lower cutoff frequency of approximately 26 kHz, and an upper cutoff frequency that depends upon the particular xDSL service.

Existing SDSL (and other xDSL) systems have drawbacks that include inefficiencies in assigning framework for channelized voice signals. In addition, existing dynamic rate repartitioning (DRR) schemes lack robustness, lack immunity to noise and contain other drawbacks that also hamper efficient operation. Other drawbacks also exist.

### SUMMARY OF THE INVENTION

The invention provides a system and method for enabling DRR that supports multiple, simultaneous voice call events. In addition the invention provides for DRR that support the activation and deactivation of bit synchronous PCM timeslots within a well-defined period of time (e.g. not to exceed 100 ms) that can accommodate any voice call control signaling procedures, DRR that provides for robust communication of the DRR signaling protocol between the line terminal (LT) and the network terminal (NT), DRR that supports periodically refreshing the status of the bit synchronous PCM timeslots and DRR that aligns with proposed DSL bearer requirements. Other advantages and features of the invention also exist.

### BRIEF DESCRIPTION OF THE DRAWINGS

FIG. 1 is a schematic illustration of a reference model to define the processing elements in support of transporting synchronous PCM voice channels simultaneously with a data channel according to some embodiments of the invention.

FIG. 2 is a schematic illustration of a dual-bearer IFS-IC framing mode for support of channelized voice according to some embodiments of the invention.

FIG. 3 is a schematic illustration of a recommended framing as defined by a voice-processing block according to some embodiments of the invention.

FIG. 4A shows voice channel identification via voice processing block 106 according to some embodiments of the invention.

FIG. 4B shows transmission of the time slots resulting from various DRR commands according to some embodiments of the invention.

FIG. 5A is another schematic representation of the payload block of FIG. 3 according to some embodiments of the invention.

FIG. 5B is a schematic chart showing possible definitions of the Z-bit channel throughout the superframe according to some embodiments of the invention.

FIG. 6 is a schematic representation of a definition for a DRR Control Byte according to some embodiments of the invention.

FIG. 7 is a schematic representation of a DRR Channel ID Byte according to some embodiments of the invention.

FIG. 8 is a schematic chart representing potential DRR commands according to some embodiments of the invention.

FIG. 9 is a schematic DRR signal flow diagram under normal operation executing a DRR event according to some embodiments of the invention.

FIG. 10 is a schematic of the associated timing diagram for a typical execution of a DRR event according to some embodiments of the invention.

### DETAILED DESCRIPTION OF THE DRAWINGS

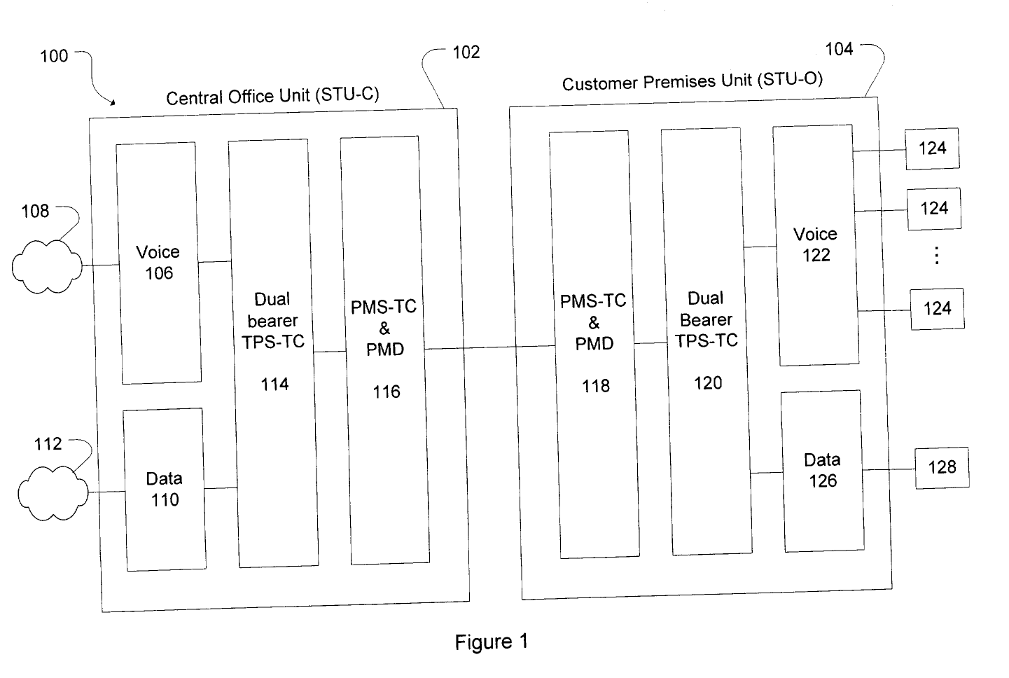

FIG. 1 shows a reference model to define the processing elements in support of transporting synchronous PCM voice channels simultaneously with a data channel according to some embodiments of the invention. The core modem may be based on SDSL, PMS-TC, and PMD definitions. To provide simultaneous PCM voice and data, it may be desirable to provide a dual bearer TPS-TC, where one bearer carries the bit synchronous PCM voice channels and the other bearer carries the asynchronous data channel.

As shown schematically in FIG. 1, system 100 may comprise processing elements at one or more office units 102 and at one or more customer premises 104. Office unit 102 may provide voice processing 106 to process voice signals from one or more voice networks 108. Similarly, data processing 110 may be provided to process signals from one or more data networks 112. Dual bearer TPS-TC processing 114 and PMS-TC and PMD processing 116 may be provided at the office unit 102 and dual bearer TPS-TC processing 118 and PMS-TC and PMD processing 120 may be provided at the customer premises unit 104. Customer premises unit 104 may also comprise voice processing 122 in communication with one or more telephone devices 124 and data processing 126 in communication with one or more computer devices 128.

Voice processing 106 in FIG. 1 may define the framing structure of the PCM voice channels and the signaling channel. Voice channels may be provisioned statically or dynamically. With static provisioning, the required number of time slots are determined and set at initialization and are transported in the bit synchronous bearer channel. If a voice channel is active, the timeslot carries PCM voice samples; if the voice channel is inactive, the timeslot carries dummy data.

With dynamic provisioning, the PCM timeslot may be activated and deactivated on an as needed basis. When a timeslot is active, the supporting bandwidth is allocated in the bit synchronous bearer channel. The asynchronous bearer channel uses the remaining bandwidth in support of the data application. When the voice timeslot becomes deactivated, the corresponding bandwidth is removed from the bit synchronous bearer and allocated to the asynchronous data bearer. The overall line bit rate stays the sane. In some embodiments, the voice processing 106 may initiate the dynamic rate repartitioning (DRR) commands to the dual-bearer TPS-TC 114.

In some embodiments, data processing 110 provides the data channel interface to the dual-bearer TPS-TC 114, which then multiplexes the two bearer channels for transport over the SDSL core modem.

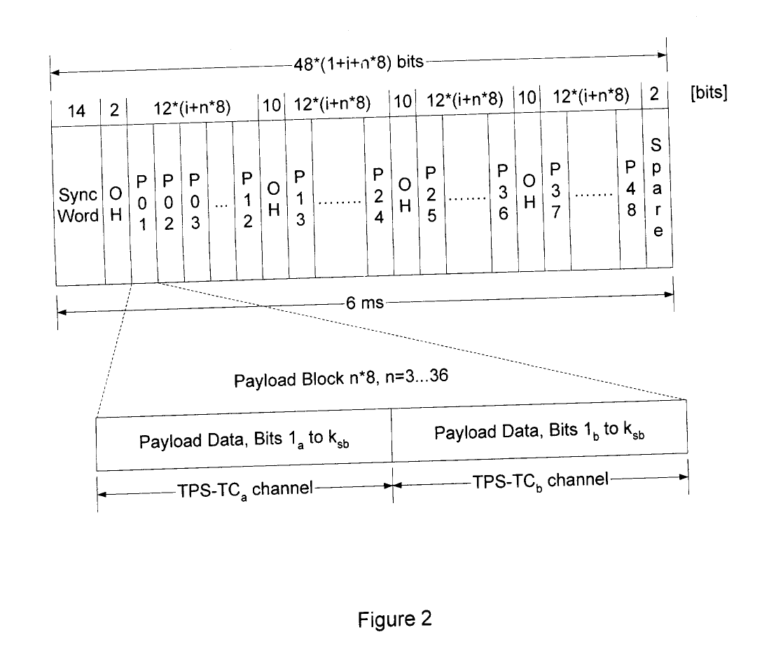

A recommended dual-bearer framing mode for support of channelized voice is shown in FIG. 2. As recommended by the European Telecommunications Standards Institute (ETSI) (in ETSI TS 101 524, section A.9, November 2001) the first bearer, i.e. bits 1ₐ through kₛₐ, may be used to transport the bit synchronous PCM voice time slots plus a channel dedicated for the transport of voice signaling. The channelization structure within this bearer channel may be defined specifically for the voice application.

In Dual-Bearer Mode, each Payload Sub-Block may be split between two separate TPS-TC instances. The TPS-TC modes may be negotiated independently in a pre-activation communication channel (PACC) and there may be no direct interaction between them.

As shown in FIG. 2, TPS-TCₐ may be assigned the first kₛₐ bits of each payload block, and TPS-TC_{b} may be assigned the last k_{sb} bits of each payload bock. For each of the two TPS-TCs, the kₛ bits assigned to it may be treated as if they constituted a complete Payload Sub-Block, and appropriate framing may be applied.

In some embodiments, the line clock may be frequency locked to the clock of the bit synchronous bearer. Alternatively, if pulse stuffing in the PMS-TC frame is desired as the mechanism for passing timing information end-to-end, then the synchronous bearer channel may be the reference channel for determining the stuff/delete operations.

Embodiments of the invention may vary according to the set of technical requirements for the implementation of dynamic rate repartitioning (DRR). In some embodiments, the use of a TPS-TC signaling channel using a dedicated Z-bit signaling channel allows for a robust and reliable implementation of DRR. Consequently, in each voice frame, one bit called the Z-bit may be allocated for transport of TPS-TC signaling between the central office 102 and customer premises 104 SDSL units. It is this channel that may transport the commands in support of DRR. The equivalent bit rate for the Z-bit channel is 8 kb/s.

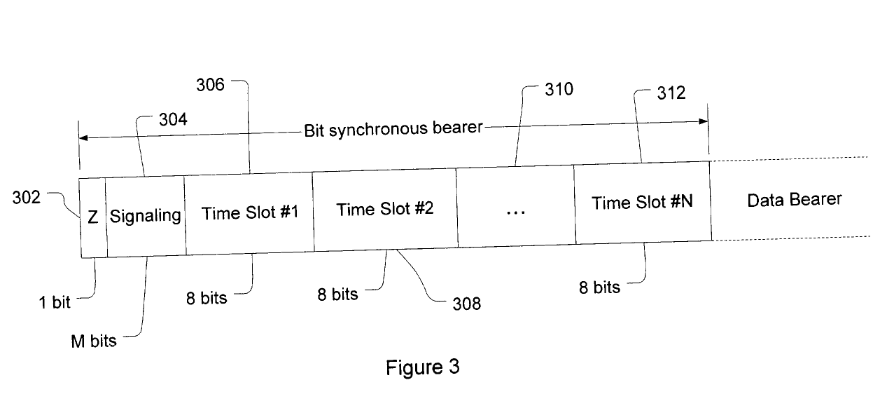

FIG. 3 is a schematic of recommended framing as defined in the voice-processing 106 according to some embodiments of the invention. The one bit Z-bit is indicated at 302.

M bits may be allocated for the signaling channel 304, which transports the signaling information between customer premises unit 104 and the network in support of the voice service. The equivalent bit rate for the signaling channel is M*8 kb/s.

The following remaining bits 306, 308, 310, 312 may carry the active PCM voice channels, where each channel contains 8 bits for an equivalent bit rate of 64 kb/s per voice channel. Up to N voice channels may be supported, where the value of N is any suitable value.

Z-bit 302 and voice signaling channel bits 304 are transmitted every frame. The PCM voice channel bits 306-312 may only be transmitted when the voice channel is active. For example, if there are two active voice channels, the voice frame would contain M+1+2*8=M+17 bits. For N active channels, the frame size would be M+1+N*8 bits. If no voice channels are active, then the minimum voice frame size is M+1 bits.

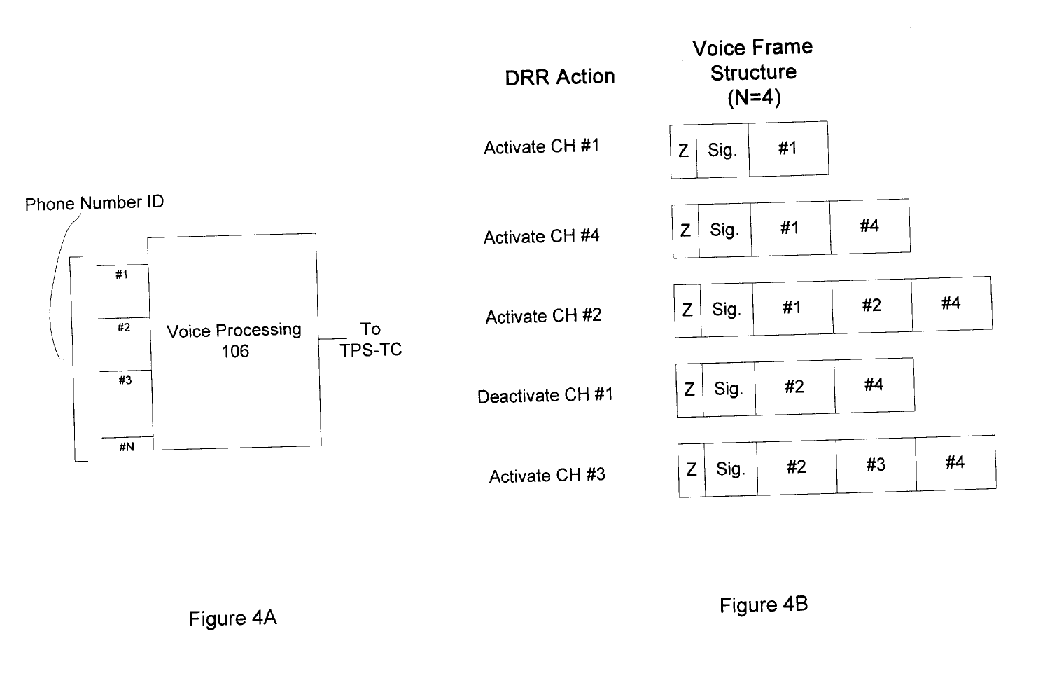

The time slots 306-312 may be arranged in order of increasing identification number. FIGS. 4A-4B show an example of the arrangement of the PCM voice channel timeslots per DRR event or action. FIG. 4A shows voice channel identification via voice processing block 106 according to some embodiments of the invention (a similar figure may be drawn for voice processing block 122). If no voice channels are active, then the Z 302 and Signaling 304 channels are transmitted; no time slot bits 306-312 are transmitted. The remainder of the line bit rate is allocated to the asynchronous data channel. FIG. 4B shows transmission of the time slots resulting from various DRR commands according to some embodiments of the invention. As shown in FIG. 4B, the time slots may be transmitted in order of identification number.

As discussed above, in order to, among other things, reduce the response time and to improve the protocol robustness of the procedures to activate and deactivate PCM voice channels over the bit synchronous portion of the SDSL frame, embodiments of the invention implement a one-bit Z-channel, at 8 Kbps, that is dedicated to the DRR protocol operation. This DRR protocol may be modeled as being exchanged between the TPS-TC in a line termination unit and the TPS-TC in the network termination unit.

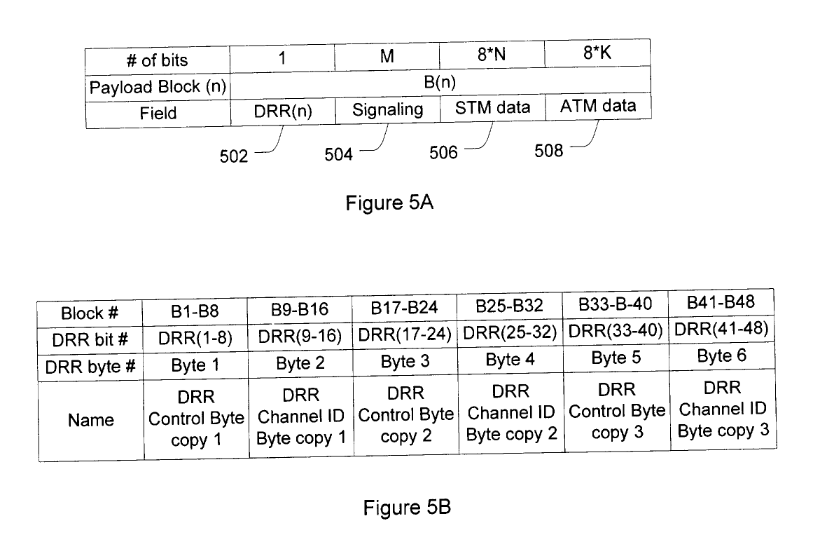

One embodiment of a frame structure and dedicated DRR channel are shown in FIG. 3. FIG. 5A is another schematic representation of the payload block of FIG. 3 according to some embodiments of the invention. For embodiments employing a single Z-bit (e.g., 302, 502), a total of 48 bits, or six bytes, per SDSL super-frame may be dedicated to transferring the DRR protocol. In the representation shown in FIG. 5A, the Z-bit is represented as DRR(n) bit (item 502). As also shown in FIG. 5A, Signaling block 504 may comprise M bits, STM data 506 may comprise 8*N bits and ATM data 508 may comprise 8*K bits.

FIG. 5B is a schematic chart showing possible definitions of the Z-bit channel throughout the superframe according to some embodiments of the invention. As shown in FIG. 5B, the 48 block per SDSL superframe may comprise 48 DRR bits or 6 DRR bytes (i.e., one DRR bit per data block).

As also indicated in FIG. 5B, the DRR Control Byte may be duplicated three times per SDSL super-frame (e.g., copy 1 to copy 3). Similarly, the DRR Channel ID Byte, which may carry the activated/deactivated time slot status information on each PCM voice channel, may be duplicated three times (copy 1 to copy 3).

In some embodiments, the correct DRR Control Byte and DRR Channel ID Byte data per super-frame may be calculated using a 2 of 3 majority algorithm. This approach enables a relatively robust DRR protocol. For example, if the SDSL frame is affected by a cyclic redundancy check (CRC) alarm, the recipient can still examine the three copies of the DRR Control Byte and DRR Channel ID Byte and determine the true value based upon an assessment of whether 2 of 3 copies agree.

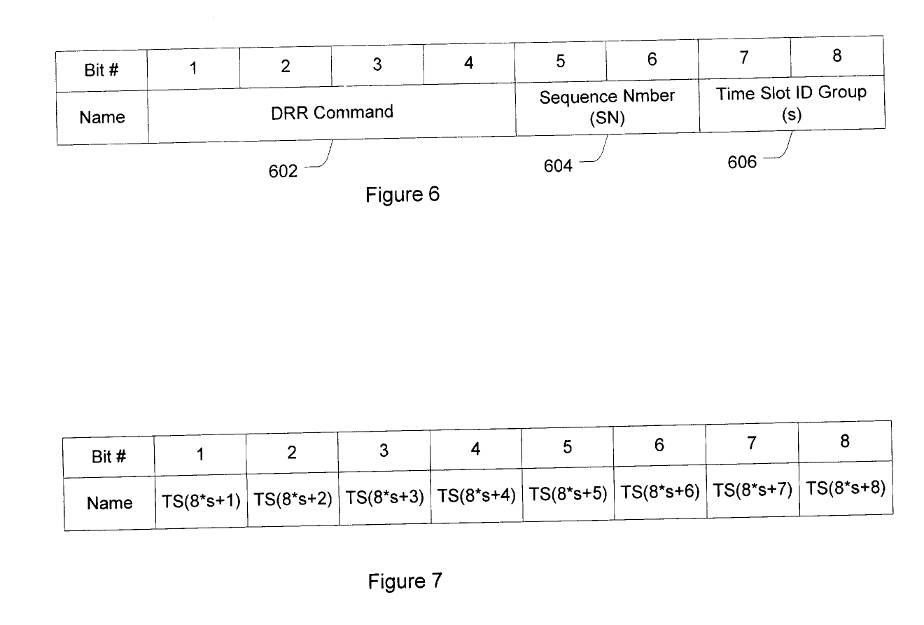

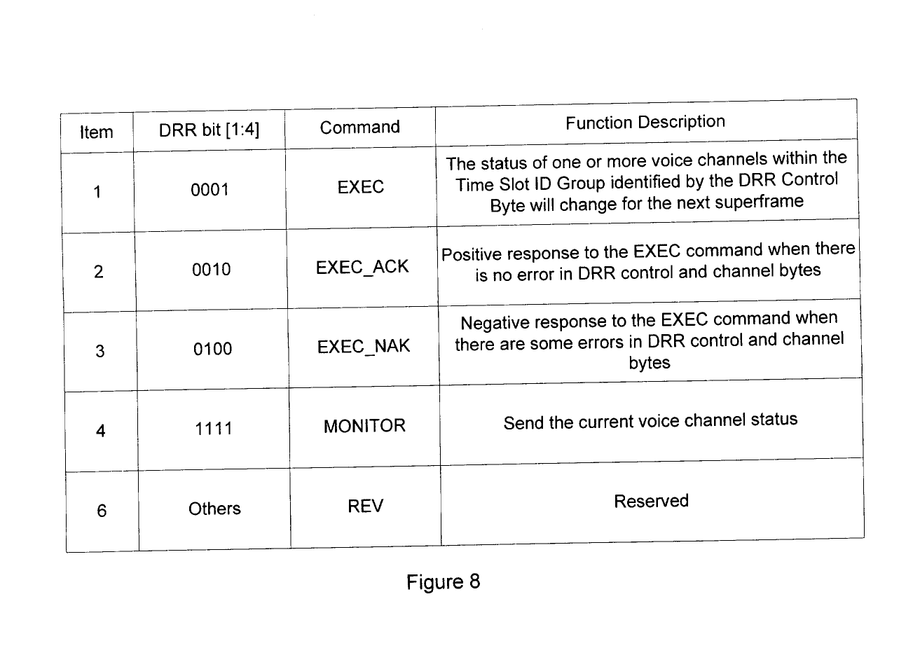

FIG. 6 is a schematic representation of a definition for a DRR Control Byte according to some embodiments of the invention. DRR Command 602 may comprise one or more of the supported 16 DRR commands, four of which are defined and listed in FIG. 8.

Sequence Number (SN) 604 may comprise a field that may be used as an error control mechanism that indicates when there is a loss of a DRR message (e.g., due to a CRC error). As discussed below, a value for a MONITOR command may be set to “00”. In some embodiments, Sequence Number 604 may count from “01” to “11” during an exchange of EXEC and EXEC_ACK/EXEC_NAK commands between the line terminal (LT) and the network terminal (NT).

Time Slot ID Group (s) 606 may comprise a field that is used when the SDSL supports more than 8 voice channels. These two bits may be used to indicate which particular timeslot belonging to the group of 8 voice-channels that the DRR Command is affecting. The ‘s’ value may be between 0 (“00”) and 3 (“11”). With this structure, up to 32 time slots may be supported.

FIG. 7 is a schematic representation of a DRR Channel ID Byte according to some embodiments of the invention. As shown in FIG. 7, the TS(8s+n) bits are the related (8³s+n) voice channel status (where s=the Time Slot ID Group, and n=the time slot in that group). If the bit value is ‘1’, the related voice channel is enabled (i.e., currently active with a voice call, or the PCM channel is in the process of being established for a new voice call. If the bit value is a ‘0’, the related voice channel is disabled (i.e., this PCM channel is no longer supporting a voice call, and this bandwidth is no available for asynchronous data).

FIG. 8 is a schematic chart representing potential DRR commands according to some embodiments of the invention. Other commands are possible.

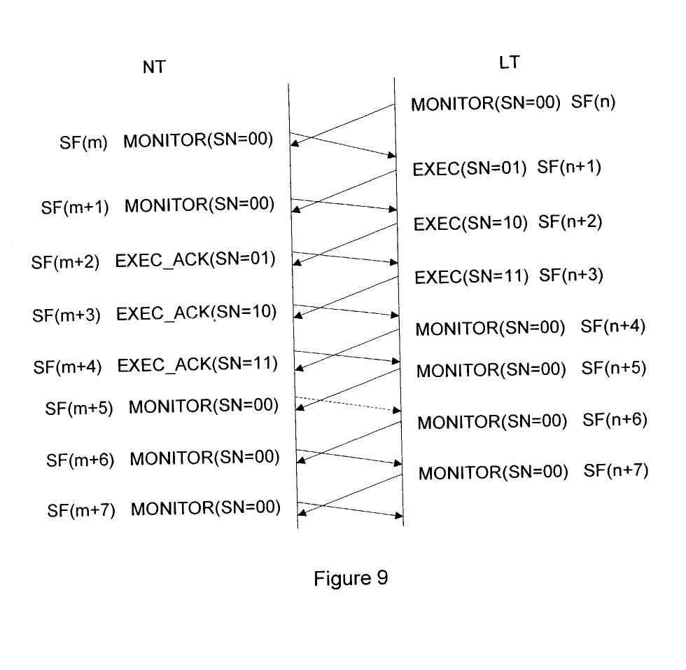

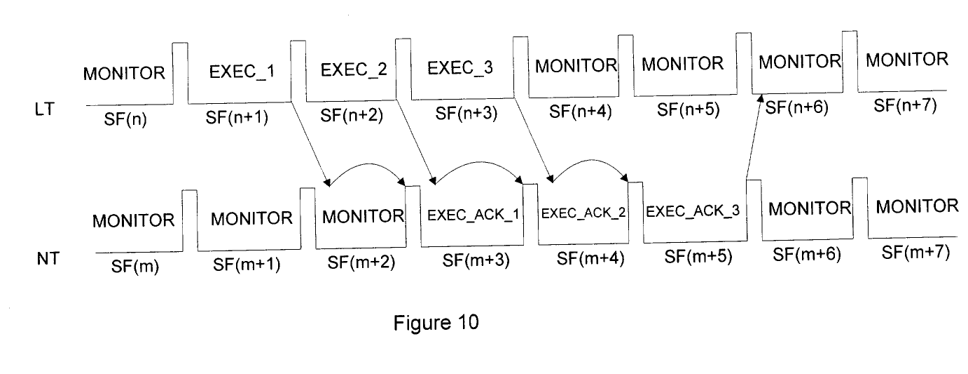

FIG. 9 is a schematic DRR signal flow diagram under normal operation executing a DRR event according to some embodiments of the invention. FIG. 10 is a schematic of the associated timing diagram for a typical execution of a DRR event according to some embodiments of the invention.

As shown in FIG. 9, down stream voice channel may change the time slot mapping at the SF(n+7) super-frame after three contiguous EXEC command and any EXEC_ACK is received. In addition, up stream voice channel may change the time slot mapping at the SF(m+5) super-frame after a third EXEC_ACK command. Three super-frames delay may cover all the possible conditions for LT to receive last EXEC_ACK(SN=11) command.

As shown in FIG. 10, for some embodiments, the longest delay for NT to respond to the EXEC command is almost one superframe. In addition, for the LT to receive the last response from the NT, three superframes may be needed. A downstream path to change the voice time slot may occur at the seventh superframe from the EXEC_{—}1 command. An upstream change to the voice channel time slot may occur at the superframe that is after the EXEC_ACK_3 command. Other configurations are possible. The protocol description below references FIGS. 9-10.

As shown in FIGS. 9-10, in some embodiments, a voice channel activation and deactivation may be initialized by the “EXEC” DRR command from LT side, downstream direction. The “EXEC” DRR command may be sent in three successive SDSL frames with the related channel byte information to which the EXEC command applies. More than one voice channel within the Time Slot ID Group can be handled at the same time.

In some embodiments, after EXEC DRR command has been sent in three successive frames, the voice channels will be activated or deactivated in the subsequent 4^{th} superframe, downstream direction. The “SN” number may be used for the “EXEC” DRR command counter from “01”, “10”, to “11” in successive frames. Within the same frame, each copy of the “EXEC” DRR command contains the same “SN” number.

In some embodiments, for every SDSL super-frame, the receiver, NT, must send an “EXEC ACK” or “EXEC_NAK” DRR command back to the LT when the command is not MONITOR, check the SN number and command fields. The procedures for coding the SN as described above may also apply to the “EXEC_ACK” or “EXEC_NAK” DRR commands.

The NT receiving a frame that contains a DRR command may use a 2-out-of-3 majority algorithm to figure out the correct voice channel to activate/deactivate. Of the three frames containing the same DRR command (where the SN is incremented by one each time), if there is only one correct DRR command received, the NT should still change the voice channel status at the end of EXEC command based on the SN number to figure out the correct super-frame number.

The upstream voice channel activation/de-activation is done after three EXEC_ACK/EXEC_NAK, if there is at lease one EXEC_ACK command as described above. If no correct DRR command is received, the NT may maintain the current voice channel status. The procedures associated with the MONITOR command may also still apply. If there is some data error, it will be recovered from by the LT on the next EXEC command.

The LT side may decide to re-issue the same DRR command based on the EXEC_ACK, and EXEC_NAK commands received. However, voice channel activations and deactivations in the downstream direction should always be executed after transmitting the “EXEC” DRR command three times.

The SN, channel-byte, and Time Slot ID Group number of EXECACK/EXEC_NAK should be the same as the received “EXEC” DRR commands. The LT side may be based on the EXEC_ACK return command to figure out whether the voice channel activation or deactivation command is complete.

The DRR commands are typically issued from LT to NT. The upstream direction is based on the EXEC_ACK/EXEC_NAK command to change the voice channel status. If one or more EXEC.ACK are received, then change the voice channel activation or deactivation status after the third transmission (i.e., SN=“11”) of EXEC_ACK DRR command, otherwise the original value may be kept.

When there are no EXEC, EXEC_ACK. and EXEC_NAK commands, the MONITOR command should be issued. The SN number may be set to “00” for MONITOR command. There may be no ACK command required for the MONITOR command. The MONITOR command may be used on an ongoing basis (unless DRR commands need to be exchanged) to send the voice channel byte/time slot byte to maintain the correct voice channel activation or deactivation status on either side of the SDSL.

The following discussion sets out some definitions for system-level requirements for DRR. These system level requirements help to ensure that the DRR signaling protocol and procedures meet the needs of the SDSL access network. In general, the following considerations should be evaluated when defining a DRR exchange mechanism: minimizing the time to activate and deactivate a PCM voice timeslot; allowing for allocation and deallocation of more than one timeslot in a very short period of time to avoid or minimize the impact of queuing delays on voice call processing events; and providing some form of robustness or immunity to noise events in the signaling protocol dedicated to DRR.

With the recognition of either the establishment or clearing of a voice call, the discussion above sets forth embodiments of the invention where a two-step procedure to repartition the SDSL frame may be implemented. Step one is to exchange an updated list of timeslot assignments between the LT and the NT by using the B Channel Allocate and B Channel Allocate Ack messages. These messages may be carried over the SDSL embedded operations channel (eoc). Step two is to accomplish the subsequently transition to frames with the new time slot allocation by an exchange of messages between the LT and the NT which are defined by SDSL overhead (SOH) bits. The synchronization cycle is defined by the messages Sync Demand, Sync Response, and Sync Confirmation. The switch to the new SDSL frames occurs after the Exec Ack (or Exec Ack New) and Exec Complete messages are successfully exchanged. The first new upstream or downstream SDSL frame after a successful repartition contains the Done message. In other words, this exchange of SOH messages constitutes exchanging DRR signaling between the TPS-TC process.

In a voice call control system, it is very likely that multiple call events (a combination of “on-hooks” and “off-hooks”) will occur in a short time interval. Consequently, it is desirable that the procedures that activate and deactivate the appropriate synchronous PCM voice channels correlate with the updated timeslot assignments. However, existing frame transition protocols typically do not provide a way to correlate between the SOH messages and multiple B Channel allocation requests. Therefore, each voice channel event (activation or deactivation of a voice bearer timeslot) must be followed by a sequence of SOH messages to change the SDSL framing for that event before being able to handle the next event. This approach to DRR is unable to handle more than one voice channel event at a time.

It is useful to establish a reference time Tref to define the time required to transition to frames with the new timeslot allocation. Tref may be measured as the interval between the LT sending the Sync Demand and the Sync Confirm. The total time required to transition to the new SDSL frame is defined to be (2+n)Tref where n=0, 1, 2, . . . , and n=0 is the default value. The parameter n may be defined by the hand-shaking procedure.

Existing efforts have focused mainly on the second step, the time necessary to exchange the SOH messages, in calculating how long it takes to change the SDSL frame in response to the establishment or clearing of a voice call. At n=0, this is estimated to be 60 ms (10 superframes or 2*T_{ref}), assuming no cyclic redundancy check (CRC) errors corrupt the frames which would cause the running time to increase. However, to fully appreciate the time required to activate or deactivate a voice bearer timeslot, one must also consider Step 1, the time needed to exchange B Channel Allocate and B Channel Allocate Ack messages.

Following the proposal that B Channel Allocate and B Channel Allocate Ack be carried over the eoc, after taking into account the entire HDLC frame, each message will require five bytes for transmission (assuming no more than eight PCM voice channels). The coc is typically a slow speed channel (about 3.3 kbps) due to the fact that only 20 bits are allocated to the eoc in each SDSL superframe. Assuming no eoc processing delays at either the LT or the NT, it will take 4-8 superframes, or 24-48 ms, to exchange the B Channel Allocate and B Channel Allocate Ack messages. Adding this time to what is necessary to exchange SOH messages puts the time required to activate or deactivate a voice bearer timeslot closer to 100 ms.

The eoc also carries other traffic with the requirement that the maximum length of a frame is 75 octets. Since the B Channel Allocate and B Channel Allocate Ack messages support voice traffic, they should be given a higher priority for processing over management events that are not time critical. Unfortunately, the eoc does not have such a queuing mechanism. Consequently, the B Channel AllocatelAck messages could get queued up behind other messages before it can be transmitted. This could add substantial delay to the time that is required just to transmit the messages across the eoc.

Finally, CRC errors can have a significant impact on the exchange of SOH messages. It is suggested that the DRR procedure may become more immune to line disturbances if the switching instances are arbitrarily delayed by multiples of T_{ref} (i.e., n>0). However, with T_{ref}=30 ms, this will add significant time to completing the DRR process. Clearly, Layer 3 voice call establishment and clearing events could be impacted, especially in systems based on North American standards where call control timer values are short (frequently on the order of 200 ms).

In some embodiments, a CRC is generated for each SDSL frame and is transmitted on the following frame. All bits in the frame except the synchronization word, CRC bits, and the stuff bits are covered by the CRC. If a CRC anomaly is declared, the entire frame is discarded, which includes the SOH messages of Step two above. Unfortunately, it is not possible to determine if the SOH bits #24 and #36 are valid once a CRC error is declared in the frame. While the 2-bit SOH messaging structure summarized in Step two above provides good alignment with the SDSL superframe, it is severely affected by CRC errors. Corrupted frames can add undefined delays in transitioning to the frames with the new timeslot allocation. Such delays can have a serious impact on the performance of voice call control signaling.

In some embodiments, the LT may periodically transmit the B Channel Allocate message to the NT as a means of checking the status of the voice timeslots. This can be used to ensure that the NT is in sync with the LT, and it can be done during periods of time when voice channels are not being established or cleared.

In some embodiments, POTS and ISDN timeslots may be temporarily allocated to the ATM bearer part of the SDSL frame without changing their slot position. However, this may be inconsistent with positions being taken in other proposals for standards. For example, in the VoDSL Working Group of the DSL Forum and in ITU-T Q4/SGI5 the voice bearer timeslots and the ATM bearer part are grouped together.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

We claim:

1. A system for providing a dynamic rate repartitioning system comprising:
a simultaneous voice call event device that supports multiple, substantially simultaneous voice call events;
a bit synchronous PCM timeslots activation device that supports the activation and deactivation of bit synchronous PCM timeslots within a well-defined period of time; and
a refresh device that supports refreshing the status of the bit synchronous PCM timeslots.

2. A method for providing a dynamic rate repartitioning, the method comprising:
providing a simultaneous voice call event device that supports multiple, substantially simultaneous voice call events;
providing a bit synchronous PCM timeslots activation device that supports the activation and deactivation of bit synchronous PCM timeslots within a well-defined period of time; and
providing a refresh device that supports refreshing the status of the bit synchronous PCM timeslots.
